(19) United States
(12) Patent Application Publication
(10) Pub. No.: US 2020/0029606 A1
(43) Pub. Date: Jan. 30, 2020

(54) Snack Food Pellets

(71) Applicant: Frito-Lay Trading Company GmbH, Berne (CH)

(72) Inventors: Suzanne DAVIES, Leicestershire (GB); James WILLIAMS, Leicestershire (GB)

(21) Appl. No.: 16/484,494

(22) PCT Filed: Feb. 8, 2018
(86) PCT No.: PCT/EP2018/053211

§ 371 Date: Aug. 8, 2019

(30) Foreign Application Priority Data
Feb. 8, 2017 (GB) 1702036.3

(51) Int. Cl. A23L 19/18; A21D 13/043; A23P 10/25; A23L 7/13

(52) U.S. Cl. CPC A23L 19/19; A21D 13/043; A23V 2002/00; A23L 7/13; A23P 10/25

(57) ABSTRACT

A snack food pellet comprising a plurality of starch granules forming a layer, the granules comprising ungelatinized starch, the granules being pressed together into mutual contact to form an agglomerate of the starch granules. Also disclosed are a method of manufacturing such a snack food pellet and a method of producing an expanded snack food piece from such a snack food pellet.

### CROSS-REFERENCE TO RELATED APPLICATIONS

This application is a US 371 Application from PCT/EP2018/053211 filed Feb. 8, 2018, which claims priority to GB Application 1702036.3 filed Feb. 8, 2017, the technical disclosures of which are hereby incorporated by reference in their entirety.

### BACKGROUND

### 1. Field of the Invention

The present invention relates to snack food pellets and to a method of manufacturing snack food pellets. The present invention also relates to a method of manufacturing a snack food produced from the snack food pellets.

### 2. Description of Related Art

The manufacture of snack food pellets, which are starch-based, is well known. Various compositions of snack food pellets are known.

Dried pellets are conventionally produced by an extrusion process with a subsequent drying step to achieve a desired moisture content in the pellet. A cereal-based dough, or a tuber-based dough, for example potato-based dough, having a typical moisture content of from 24 to 35 wt %, based on the weight of the dough, is provided. The dough is typically formed by hydrating dehydrated ingredients, such as cereal flour or potato flour. The dough is extruded through a die plate having one or more die orifices. The dough is shaped in cross-section upon exiting the extruder, and the extruded dough is cut to form a plurality of individual dough pieces of desired mass, shape and dimensions. The drying step dries the pieces to form pellets having a typical moisture content of from 10 to 12 wt % based on the weight of the pellets. Such a moisture content is provided to achieve both shelf-life stability of the pellets and expansion upon frying. The pellets are then cooked, for example by frying in oil, which causes expansion the pellets to form an expanded snack food of a desired shape and configuration. The expansion is at least partially achieved by the moisture content in the pellet forming steam at the elevated frying temperature and the steam causes the starch matrix, which has become gelatinized and plasticized at the elevated frying temperature, to expand.

There is a generally recognised desire in the snack food manufacturing art to reduce manufacturing costs of the snack food product without compromising the product quality. It is necessary to ensure that any new or modified cooking process still produces a high quality product to the consumer which meets customer acceptance and is reliably and consistently achievable despite high production volumes. In particular, snack food chips are normally required to meet very strict customer acceptance criteria for the respective product, for example having specific moisture and oil-in-chip contents, and the desired taste, organoleptic and other sensory attributes.

The product design of snack food pellets made by conventional means is constrained by the correlation of certain product attributes which are affected by changes in composition or process variables. For example, increased starch gelatinization can deliver a more aerated structure through increased pellet expansion and a softer, more melting texture. In addition, the conventional pellet production process, incorporating extrusion of a homogeneous mass, yields highly homogeneous products.

For example, therefore, the consistent achievement of a pre-specified moisture composition of a pellet having pre-specified mass, shape and dimensions is important for achieving consumer acceptance in the resultant cooked shack food piece. There is a challenge to reduce pellet manufacturing costs and to continue to produce the required product attributes.

The present invention aims at least partially to solve these problems of known snack food pellets and their manufacture.

### SUMMARY

The present invention accordingly provides a snack food pellet comprising a plurality of starch granules forming a layer, the granules comprising ungelatinized starch, the granules being pressed together into mutual contact to form an agglomerate of the starch granules.

The present invention also provides a method of manufacturing a snack food pellet, the method comprising the steps of:
i. providing a dough comprising a plurality of starch-based granules, the granules comprising ungelatinized starch, and a moisture content of from 15 to 20 wt % based upon the weight of the dough;
ii. locating a portion of the dough in a heated pressing apparatus; and
iii. pressing the dough portion in the heated pressing apparatus to form a pellet comprising a plurality of starch granules forming a layer, the granules comprising ungelatinized starch, the granules being pressed together into mutual contact to form an agglomerate of the starch granules.

The pellet has a shape and composition for subsequent expansion in hot oil, hot air or a microwave to form an expanded snack food product.

The present invention further provides a method of producing a snack food, the method comprising the steps of:
i. providing a plurality of pellets according to the present invention or manufactured according to the method of the present invention; and
ii. expanding the pellets during a cooking step to produce a plurality of snack food pieces.

The present invention further provides a snack food produced by the method of the present invention wherein the snack food comprises a cellular microstructure having cellular voids with an average elongation, defined as the maximum cellular void length divided by the minimum cellular void width within the range of from 1.41 to 1.46.

Preferred features of all of these aspects of the present invention are defined in the dependent claims.

The preferred embodiments of the present invention are predicated on the finding by the present inventors that the use of heat pressing can provide a number of advantages and technical effects as compared to conventional extrusion technology for manufacturing pellets.

First, the heat pressing process enables the use of a lower moisture content for the dough. The dough is heat pressed into a stationary mould by a moving platen, or is compressed between opposed platens, either or both of which may move. During heat pressing, the dough is subjected to reduced shear forces and flow as compared to an extrusion process. Therefore, the dough can have a higher viscosity than is typically used for extrusion, and consequently a lower moisture content.

The heat pressed dough is not required to flow through a screw barrel or to be moulded into a shape on exiting the extruder. The lower moisture content enables the elimination of any drying step subsequent to the pressing step in order to provide a moisture content suitable for subsequent cooking and expansion of the starch to form a cooked expanded snack food piece, for example a chip. The avoidance of a subsequent drying process as compared to the known extrusion process simplifies the pellet manufacturing process and reduces the production costs.

In a particularly preferred embodiment, the dough moisture is from 15 to 18 wt % for heat pressing as compared to a typical dough moisture of from 24 to 35 wt % for extrusion. The final pellet moisture is reduced during heat pressing as a result of some moisture evaporation at the elevated temperature during the heat pressing step, and is most preferably from 10.5 to 11.5 wt %, which is an ideal range for achieving expansion of the pellet during cooking, for example frying. The heat pressing can lower the pellet moisture content to this desired range without requiring a drying step, whereas extrusion generally does require an additional drying step to condition the pellet for reliable and uniform expansion during cooking.

Second, the heat pressing process was found to be readily controllable to produce a new microstructure to the starch-based pellet. The heat pressing process significantly lowers or eliminates shear forces acting on the starch, and the low shear and low moisture enable the heat pressing process to minimize or eliminate starch gelatinisation. Consequently, the substantially ungelatinized starch granules in the dough substantially remain as substantially ungelatinized starch granules in the pellet. The pellet comprises a unique microstructure of compacted and agglomerated starch granules, with a minimal or no continuous starch matrix between the granules.

By limiting starch gelatinisation, the final product characteristics of the expanded snack food piece can be controlled. The presence of an agglomeration of compacted starch granules in the pellet provides a high level of uniformity in the pellet microstructure, and a high density of granules per unit volume of the pellet. This in turn provides a very high number of nucleation points for starch expansion, as a result of steam generation, during cooking, for example during frying. This structure provides new textures in the snack food pieces.

The high proportion of ungelatinized starch, which is crystalline rather than amorphous in microstructure, in the granules of the pellet is also believed by the present inventors to result in a higher expression in the final expanded snack food piece of the characteristic of the source of the starch component. For example, when potato starch granules are employed, the resulting substantially ungelatinized starch granules in the pellet provide that the expanded snack food piece exhibits a more pronounced potato characteristic than would be expected by an extruded composition, which generally results in a high degree of starch gelatinisation in the pellet.

Third, the heat pressing applies a pressure to the starch granules which compacts the granules to form an agglomerate of the starch granules which mutually contact each other. The pellet is in the form of a layer. There is no or only minimal continuous starch matrix, and there is no or only minimal gelatinised or amorphous starch.

Any gelatinised or amorphous starch, which is between the substantially ungelatinized and substantially crystalline starch granules, may be derived from some gelatinization of surfaces of some or all of the starch granules and/or some gelatinized starch which either has been added as a pre-gelatinized starch ingredient to the dough which is then pressed and/or has been formed during pressing from a further minor starch ingredient which is present in the dough, in addition to the starch-based granules comprising ungelatinized starch.

The starch granules are pressed together to agglomerate, but remain substantially ungelatinized. This increases the number of nucleation points for expansion in the pellet, and these nucleation points are uniformly distributed throughout the pellet microstructure. The resultant expanded snack food piece has a higher number of cellular voids uniformly distributed throughout the starch microstructure, and higher cell wall thickness, as compared to a typical snack food piece produced from an extruded pellet. This provides a crispier expanded snack food piece, and the consumer would perceive the enhanced crispiness of the product.

Fourth, in the expanded snack food produced from the pellet the cellular voids are elongated, but with a low degree of elongation as compared to an expanded snack food produced from an extruded pellet whereas the pellet is in the form of a layer where the layer is sheeted during extrusion. From the heat pressed pellet the cellular voids are elongated to a reduced extent as compared to from the extruded pellet, because the heat pressing avoids the use of a sheeting process when the starch is in a gelatinised rubbery phase. When cooked and expanded, the resultant snack food piece produced from the heat pressed pellet has a different microstructure as compared to an extruded pellet, which provides additional and novel characteristics of an expanded snack food piece.

Therefore, the heat pressing method can produce a new pellet microstructure which in turn can result in new characteristics for the final expanded snack food piece.

### BRIEF DESCRIPTION OF THE DRAWINGS

Embodiments of the present invention will now be described by way of example only with reference to the accompanying drawings, in which:

FIG. 1 schematically illustrates a process flow diagram of a method of manufacturing a snack food pellet in accordance with an embodiment of the present invention;

FIG. 2 schematically illustrates an apparatus for manufacturing a snack food pellet in accordance with the method of FIG. 1;

FIG. 3 schematically illustrates a snack food pellet produced by the method of FIG. 1; and

FIG. 4 schematically illustrates a micrograph of a pellet surface of a pellet produced by the method of FIG. 1.

### DETAILED DESCRIPTION

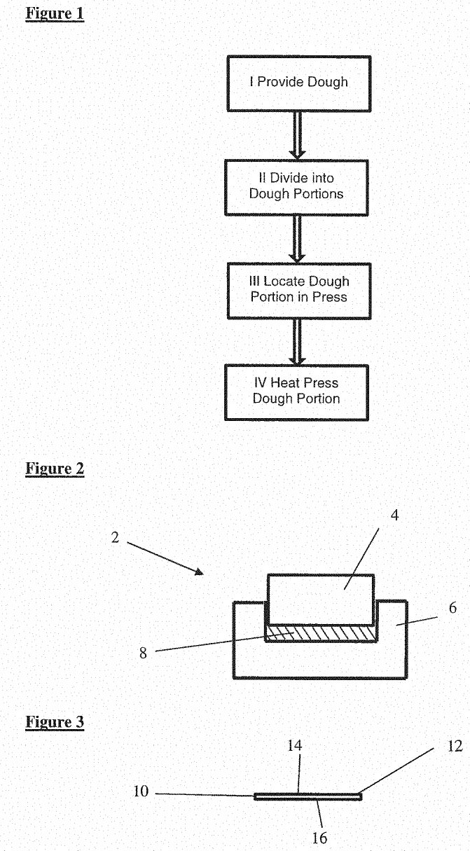

Referring to FIG. 1 of the accompanying drawings, there is schematically illustrated a process flow of a method of manufacturing a snack food pellet according to an embodiment of the present invention, and FIG. 2 illustrates an apparatus for carrying out the method.

In the method, in step I a dough is provided which comprises one or more starch-containing ingredients, derived from starch sources such as potato and cereals, for example wheat, maize, rice, oats, barley, etc. Other cereal crops could be used, as well as starch from pulses, legumes, cassava, etc. The starch-containing ingredients may be added as whole foods (e.g. potato flakes/granules; wheat flour) or as refined/isolated constituents (e.g. potato starch). The ingredients may be used individually or in combination with other starch-containing ingredients. The dough may further comprise one or more ingredients such as sugars, raising agents, seasoning, salts, emulsifiers, fats/oils, humectants, acids, bases, proteins, fibres, dairy ingredients, texture modifiers, acidity regulators or any combination thereof.

In the method, the dough comprises a plurality of starch-based granules. The starch granules comprise ungelatinized starch, and typically the starch component consists of ungelatinized starch. Typically, the plurality of starch granules comprise or consist of potato starch and the starch component of the starch-based granules is comprised of or consists of potato starch.

The dough is formed by simple mixing of the starch-based granules, and optional ingredients such as seasoning, with water to form a substantially homogeneous dough mixture. The dough has a moisture content of from 15 to 20 wt %, preferably from 16 to 18 wt %, based upon the weight of the dough. The mixing is readily controlled to provide a uniform distribution of fine water droplets throughout the dough so that a corresponding fine and uniform water distribution is present in the resultant pellet. This in turn provides a uniform expansion of the pellet as a result of localised steam generation during cooking of the pellet, for example by frying.

In step II The dough is divided into portions, typically of a pre-set weight or volume, and each portion is intended to form an individual pellet. Typically, the dough portion has a volume of from 2,000 to 8,000 mm³, preferably from 2,300 to 4,500 mm³. The dough portion may have a weight of from 1 to 4 grams, preferably 1.5 to 2 grams. The portion, prior to pressing, has a thickness of from 1.5 to 5.5 mm, preferably from 1.7 to 3.5 mm.

Then, in step III the portion of the dough is located in a heated pressing apparatus 2, illustrated in FIG. 2. The heated pressing apparatus 2 comprises a pair of pressing elements 4, 6 between which the dough portion 8 of the dough is located and pressed to form the pellet. There are upper and lower pressing elements 4, 6. The pressing elements 4, 6 are in the form of platens and typically each have a surface area of from 1250 to 1970 mm², preferably from 1520 to 1660 mm².

At least one, and optionally both, of the pressing elements 4, 6 is or are heated to a pressing temperature which is from 100 to 140° C., preferably from 100 to 120° C.

Thereafter, in step IV the dough portion 8 is pressed in the heated pressing apparatus 2 to form a pellet. The pressing time is from 10 to 50 seconds, preferably from 20 to 30 seconds. The pressing pressure is from 100,000 to 400,000 N/m² (1 to 4 Bar), preferably from 300,000 to 400,000 N/m² (3 to 4 Bar).

The temperature, pressure and pressing time are readily controlled to minimise or avoid any premature expansion of the starch as a result of stream generation in the starch at the elevated temperature of heat pressing.

Referring to FIG. 3, the resulting pellet 10 comprises a plurality of starch granules pressed together to form an agglomerate of the starch granules. The pellet 10 is in the form of a layer 12. The structure and texture of the snack food product after expansion is strongly influenced by the nature and composition of the starch-containing ingredients in the pellet 10.

Typically, the pellet 10 consists of the plurality of starch granules pressed together to form the agglomerate and the pellet does not comprise a continuous starch-based matrix between the granules.

The pellet 10 typically comprises from 90 to 99 wt % starch granules and from 1 to 10 wt % continuous starch-based matrix between the granules, preferably from 95 to 99 wt % starch granules and from 1 to 5 wt % continuous starch-based matrix between the granules, each based upon the weight of the total starch in the pellet 10.

The pressed pellet 10 has a volume of from 1200 to 3800 mm³, preferably from 1200 to 2700 mm³. The layer 12 has two opposite surfaces 14, 16 and a thickness therebetween. The thickness is from 0.5 to 4 mm, preferably from 0.7 to 1.8 mm. The two opposite surfaces 14, 16 each have a surface area of from 1250 to 1970 mm², preferably from 1520 to 1660 mm². The two opposite surfaces 14, 16 each have from 600 to 1800, optionally from 675 to 1725, starch granules per mm² of the respective surface.

The pressing time and pressing temperature are controlled to provide that the pellet 10 has a moisture content of from 9 to 12.5 wt %, preferably from 10 to 11.5 wt %, further preferably from 10.5 to 11 wt %, based upon the weight of the pellet 10.

The pressing time and pressing temperature are controlled to provide that the agglomerate of the starch granules comprises from 60 to 99 wt % ungelatinized starch and from 1 to 40 wt % gelatinized starch, preferably from 80 to 99 wt % ungelatinized starch and from 1 to 20 wt % gelatinized starch, each based upon the weight of the total starch in the pellet 10.

The resulting pellet 10 is used in a method of producing a snack food. The method comprises providing a plurality of the pellets 10 and expanding the pellets 10 during a cooking step to produce a plurality of snack food pieces. The cooking step comprises frying, baking or microwaving.

The pellet 10 may be shaped and dimensioned to provide any desired shape and dimensions to the resultant expanded snack food piece using shape and dimension selection techniques well known to those skilled in the snack food art.

The present invention will now be described in greater detail with reference to the following non-limiting Examples.

### Example 1

A starch-based dough was prepared. The dough comprised a plurality of starch-based granules consisting of ungelatinized potato starch. In particular the dough comprised 0.2 g potato flakes, 1.1 g native potato starch, 0.2 g pre-gelatinised starch, and 0.0957 ml water.

The dough was substantially homogeneous and had a moisture content of 16 wt %, based upon the weight of the dough. A dough portion having a volume of 3000 mm³ and a weight of 1.6 grams was placed in an aluminium foil tray and then located in a heated pressing apparatus. The heated pressing apparatus comprises a pair of platens, a stationary lower plate on which the tray was positioned and an upper movable platen which was lowered down onto the dough portion to press the dough to form a pellet in the form of a disc-like layer. The pressing temperature was 120° C., the pressing time was 30 seconds, and the pressing pressure was 400,000 N/m² (4 Bar).

The resultant pellet had a uniform starch microstructure, as summarised in Table 1. It was determined that with this moisture content, pellet formation by heat pressing was fully successful.

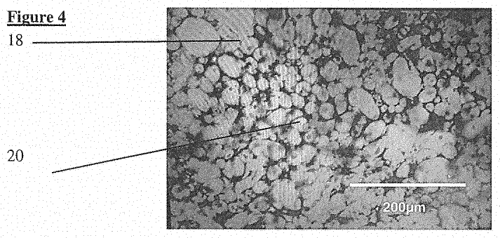

The pellet surface was examined by microscopy and a representative view of the pellet surface, indicated by reference numeral 18, is shown in FIG. 4. It may be seen that the pellet consists of a compacted agglomerate of starch granules, a granule being indicated by reference numeral 20, which remained intact, and with a minimal continuous starch matrix, of gelatinized, and amorphous, starch was formed.

The starch granules are derived from the potato flakes and the native potato starch ingredients. The minor proportion of continuous starch matrix, of gelatinized, and amorphous, starch is primarily derived from the pre-gelatinised starch ingredient.

The average number of starch granules per 200 μm×200 μm area was within the range of from about 27 to about 69. This equates substantially to from 600 to 1800, typically from 675 to 1725, starch granules per mm² of the pellet surface.

The pellet was fried to produce an expanded snack. The expanded snack comprised a starch matrix including a uniform distribution of cellular voids. The shape and dimensions of the cellular voids was analysed by microscopy and by C-Cell analysis which as used to measure the aspect ratio, or elongation of the cellular voids in the expanded snack food piece. The average cell elongation in a variety of expanded snacks produced from heat pressed pellets was analysed by C-Cell analysis; the C-Cell instrument and associated analytical software are available from C-Cell, Warrington, Cheshire, UK, (http://www.c-cell.info/). The average cell elongation is defined as: The average length to breath ratio of cells, independent of their relative orientation; Values close to 1 indicate rounded cells, and values >1 indicate greater elongation.

A variety of expanded snack food pieces produced according to Example 1 were analysed and the average cell elongation, or aspect ratio, of the cells was found to be within the range of from 1.41 to 1.46, as shown in Table 1.

TABLE 1

| | Dough | | | |
|---|---|---|---|---|
| | Moisture | Pellet | Pellet | Cell Elongation |
| | wt % | Process | Properties | Expanded Snack |
| Example | 16 | Heat | Uniform starch | 1.41-1.46 |
| 1 | | pressing | microstructure | |
| Example | 18 | Heat | Uniform starch | 1.38-1.41 |
| 2 | | pressing | microstructure | |
| Example | 20 | Heat | Uniform starch | 1.39-1.42 |
| 3 | | pressing | microstructure | |
| Comp. | 8 | Heat | Non-uniform | Unexpanded |
| Ex. 1 | | pressing | starch | therefore not |
| | | | microstructure | measured |
| Comp. | 12 | Heat | Non-uniform | Unexpanded |
| Ex. 2 | | pressing | starch | therefore not |
| | | | microstructure | measured |
| Comp. | 14 | Heat | Non-uniform | Unexpanded |
| Ex. 3 | | pressing | starch | therefore not |
| | | | microstructure | measured |
| Comp. | 25 | Heat | Non-uniform | Unable to |
| Ex. 4 | | pressing | starch | measure |
| | | | microstructure | |
| Comp. | 35 | Heat | Non-uniform | Unable to |
| Ex. 5 | | pressing | starch | measure |
| | | | microstructure | |
| Comp. | 35 | Extrusion | Uniform starch | 1.466 |
| Ex. 6 | | | microstructure | |
| Comp. | 35 | Extrusion | Uniform starch | 1.48 |
| Ex. 7 | | | microstructure | |
| Comp. | 35 | Extrusion | Uniform starch | 1.52 |
| Ex. 8 | | | microstructure | |

### Examples 2 and 3

Example 1 was repeated but with varying moisture content of the dough as shown in Table 1, Example 2 using 18 wt % moisture content and Example 3 using 20 wt % moisture content. The resultant pellets had a uniform starch microstructure. It was determined that with this moisture content range, pellet formation by heat pressing was substantially successful. A variety of expanded snack food pieces were analysed and the average cell elongation, or aspect ratio, of the cells was found to be within the range of from 1.38 to 1.41 for Example 2 and 1.39 to 1.42 for Example 3, as shown in Table 1.

### Comparative Examples 1 to 5

Example 1 was repeated but with a moisture content of the dough of 8, 12, 14, 25 or 35 wt % for Comparative Examples 1 to 5 respectively. The resultant pellets of Comparative Examples 1 to 5 each had an unacceptable non-uniform starch microstructure as summarised in Table 1. It was determined that with these moisture contents, pellet formation by heat pressing was unsuccessful in Comparative Examples 1 to 5.

Table 1 shows that there is a clearly preferred moisture content range of from 15 to 20 wt %, more preferably from 16 to 18 wt %, based upon the weight of the dough for achieving a heat pressed pellet with the desired uniform microstructure.

### Comparative Examples 6 to 8

Comparative Examples 6 to 8 were a commercial expanded snack food piece produced from an extruded pellet and sold in the United Kingdom under the trade mark Quavers® by Walkers Crisps, Leicester, UK. The extruded pellets have a high dough moisture content of 35 wt %. The known expanded snack food piece of Comparative Examples 6 to 8 were analysed by C-Cell analysis and the average cell elongation, or aspect ratio, of the cells was found to be within the general range of greater than 1.46 to 1.52 for the various Comparative Examples, providing an overall average of 1.48.

### Examples 4 to 8

A variety of expanded snacks produced from heat pressed pellets as described in Example 1 were analysed by C-Cell analysis. The results are shown in Table 2. These examples had varying proportions of native potato starch, as shown in Table 2. It was found that the average cell elongation, or aspect ratio, of the cells was within the range of 1.43 to 1.44.

TABLE 2

| | Dough | Native Potato | Average Cell Elongation |
|---|---|---|---|
| | Moisture | Starch | Expanded Snack |
| | wt % | wt % | (based on 4 replicates) |
| Example 4 | 16 | 30 | 1.43 |
| Example 5 | 16 | 40 | 1.44 |
| Example 6 | 16 | 50 | 1.43 |
| Example 7 | 16 | 60 | 1.44 |
| Example 8 | 16 | 70 | 1.43 |

The experimental data of the Examples and Comparative Examples shows that the heat pressing method to produce pellets in accordance with the present invention produces a pellet having new product attributes which are also manifested in the resultant expanded snack food piece. Therefore, the heat pressing process of the present invention can not only reduce the manufacturing costs and complexity of the pellet manufacturing process, but also can produce new product attributes which can be utilized to produce new snack food products, with new textures, mouthfeel, crispiness, etc., as compared to known products produced using pellet extrusion.

Various other modifications to the present invention will be readily apparent to those skilled in the art.

1. A snack food pellet comprising a plurality of starch granules forming a layer, the granules comprising ungelatinized starch, the granules being pressed together into mutual contact to form an agglomerate of the starch granules.

2. A snack food pellet according to claim 1 wherein the pellet comprises from 90 to 99 wt % starch granules and from 1 to 10 wt % continuous starch-based matrix between the granules, each based upon the weight of the total starch in the pellet.

3. A snack food pellet according to claim 2 wherein the pellet comprises from 95 to 99 wt % starch granules and from 1 to 5 wt % continuous starch-based matrix between the granules, each based upon the weight of the total starch in the pellet.

4. A snack food pellet according to claim 1 wherein the pellet consists of the plurality of starch granules pressed together to form the agglomerate and the pellet does not comprise a continuous starch-based matrix between the granules.

5. A snack food pellet according to claim 1 wherein the layer is an elongate layer which has two opposite surfaces and a thickness therebetween.

6. A snack food pellet according to claim 5 wherein the thickness is from 0.5 to 4 mm.

7. A snack food pellet according to claim 6 wherein the thickness is from 0.7 to 1.8 mm.

8. A snack food pellet according to claim 5 wherein the two opposite surfaces each have a surface area of from 1250 to 1970 mm².

9. A snack food pellet according to claim 8 wherein the two opposite surfaces each have a surface area of from 1520 to 1660 mm².

10. A snack food pellet according to claim 5 wherein the two opposite surfaces each have from 600 to 1800 starch granules per mm² of the respective surface.

11. A snack food pellet according to claim 10 wherein the two opposite surfaces each have from 675 to 1725 starch granules per mm² of the respective surface.

12. A snack food pellet according to claim 1 wherein the pellet has a moisture content of from 10 to 12 wt %.

13. A snack food pellet according to claim 1 wherein the agglomerate of the starch granules comprises from 60 to 99 wt % ungelatinized starch and from 1 to 40 wt % gelatinized starch, each based upon the weight of the total starch in the pellet.

14. A snack food pellet according to claim 13 wherein the agglomerate of the starch granules comprises from 80 to 99 wt % ungelatinized starch and from 1 to 20 wt % gelatinized starch, each based upon the weight of the total starch in the pellet.

15. A snack food pellet according to claim 1 wherein the plurality of starch granules comprise at least one starch derived from of a cereal or a vegetable.

16. A method of manufacturing a snack food pellet, the method comprising the steps of:
i. providing a dough comprising a plurality of starch-based granules, the granules comprising ungelatinized starch, and a moisture content of from 15 to 20 wt % based upon the weight of the dough;
ii. locating a portion of the dough in a heated pressing apparatus; and
iii. pressing the dough portion in the heated pressing apparatus to form a pellet comprising a plurality of starch granules forming a layer, the granules comprising ungelatinized starch, the granules being pressed together into mutual contact to form an agglomerate of the starch granules.

17. A method according to claim 16 wherein the dough has a moisture content of from 16 to 18 wt % based upon the weight of the dough.

18. A method according to claim 16 wherein the pressing time and pressing temperature are controlled to provide that the pellet has a moisture content of from 9 to 12.5 wt % based upon the weight of the pellet.

19. A method according to claim 18 wherein the pressing time and pressing temperature are controlled to provide that the pellet has a moisture content of from 10 to 11.5 wt % based upon the weight of the pellet.

20. A method according to claim 19 wherein the pellet has a moisture content of from 10.5 to 11 wt %, based upon the weight of the pellet.

21. A method according to claim 16 wherein the pressing temperature is from 100 to 140° C.

22. A method according to claim 21 wherein the pressing temperature is from 100 to 120° C.

23. A method according to claim 16 wherein the pressing time is from 10 to 50 seconds.

24. A method according to claim 23 wherein the pressing time is from 20 to 30 seconds.

25. A method according to claim 16 wherein the pressing pressure is from 100,000 to 400,000 N/m².

26. A method according to claim 25 wherein the pressing pressure is from 300,000 to 400,000 N/m².

27. A method according to claim 16 wherein the dough portion has a volume of from 2,000 to 8,000 mm³.

28. A method according to claim 27 wherein the dough portion has a volume of from 2,300 to 4,500 mm³.

29. A method according to claim 16 wherein the pressed pellet has a volume of from 1,200 to 3,800 mm³.

30. A method according to claim 29 wherein the pressed pellet has a volume of from 1,200 to 2,700 mm³.

31. A method according to claim 16 wherein the heated pressing apparatus comprises a pair of pressing elements between which the dough portion is located and pressed to form the pellet.

32. A method according to claim 31 wherein at least one of the pressing elements is heated to a pressing temperature.

33. A method according to claim 31 wherein the pressing elements each have a surface area of from 1250 to 1970 mm².

34. A method according to claim 33 wherein the pressing elements each have a surface area of from 1520 to 1660 mm².

35. A method according to claim 16 wherein the layer is an elongate layer and has two opposite surfaces and a thickness therebetween.

36. A method according to claim 35 wherein the thickness is from 0.5 to 3 mm.

37. A method according to claim 36 wherein the thickness is from 0.6 to 1.5 mm.

38. A method according to claim 35 wherein the two opposite surfaces each have a surface area of from 1250 to 1970 mm².

39. A method according to claim 38 wherein the two opposite surfaces each have a surface area of from 1520 to 1660 mm².

40. A method according to claim 35 wherein the two opposite surfaces each have from 600 to 1800 starch granules per mm² of the respective surface.

41. A method according to claim 40 wherein the two opposite surfaces each have from 675 to 1725 starch granules per mm² of the respective surface.

42. A method according to claim 16 wherein the portion, prior to pressing, has a thickness of from 1.5 to 5.5 mm.

43. A method according to claim 42 wherein the portion, prior to pressing, has a thickness of from 1.7 to 3.5 mm.

44. A method according to claim 16 wherein the pressing time and pressing temperature are controlled to provide that the agglomerate of the starch granules comprises from 60 to 99 wt % ungelatinized starch and from 1 to 40 wt % gelatinized starch, each based upon the weight of the total starch in the pellet.

45. A method according to claim 44 wherein the pressing time and pressing temperature are controlled to provide that the agglomerate of the starch granules comprises from 80 to 99 wt % ungelatinized starch and from 1 to 20 wt % gelatinized starch, each based upon the weight of the total starch in the pellet.

46. A method according to claim 16 wherein the pellet consists of the plurality of starch granules pressed together to form the agglomerate and the pellet does not comprise a continuous starch-based matrix between the granules.

47. A method according to claim 16 wherein the pellet comprises from 90 to 99 wt % starch granules and from 1 to 10 wt % continuous starch-based matrix between the granules, each based upon the weight of the total starch in the pellet.

48. A method according to claim 47 wherein the pellet comprises from 95 to 99 wt % starch granules and from 1 to 5 wt % continuous starch-based matrix between the granules, each based upon the weight of the total starch in the pellet.

49. A method according to claim 16 wherein the plurality of starch granules comprise at least one starch derived from of a cereal or a vegetable.

50. A method of producing a snack food, the method comprising the steps of:
i. providing a plurality of pellets according to any one of claims 1 to 15 or manufactured according to the method of any one of claims 16 to 49; and
ii. expanding the pellets during a cooking step to produce a plurality of snack food pieces.

51. A method according to claim 50 wherein the cooking step comprises frying, baking or microwaving.

52. A snack food produced by the method of claim 50 wherein the snack food comprises a cellular microstructure having cellular voids with an average elongation, defined as the maximum cellular void length divided by the minimum cellular void width within the range of from 1.41 to 1.46.
